(19) United States
(12) Patent Application Publication
(10) Pub. No.: US 2010/0045597 A1
(43) Pub. Date: Feb. 25, 2010

(54) DEVICE FOR CONTROLLING A COMPUTER SYSTEM

(76) Inventor: Gerard Popineau, Vincennes (FR)

Correspondence Address: GERARD JP POPINGAU, RUE CHARLES PATHE, VINCENNES, 94300, FR

(21) Appl. No.: 12/312,371

(22) PCT Filed: Dec. 11, 2007
(86) PCT No.: PCT/IB2007/054576

§ 371 Date: May 7, 2009

(30) Foreign Application Priority Data
Nov. 13, 2006 (FR) 0609877

(51) Int. Cl. G06F 3/033

(52) U.S. Cl. 345/157; 345/168; 345/163

(57) ABSTRACT

The invention relates to a device (1) for controlling a computer system (2) of “personal microcomputer” type, at least by a group of users by means of several pointing devices (4) having no wired link with the system (2) of “wireless mouse” type. Each of these pointing devices (4) is manipulated by each of the users and transmits, by means of a communication channel (5), binary data sequences representative of its movements and of its states to interface means (6) linked to a communication port (7) of the computer system (2). The device (1) moreover comprises means (10) of selection by a reference user of one of more of the pointing devices (4) and for rendering the others inoperative. The device is noteworthy in that the selection means (10) comprise at least one specific software module (11) and in that the interface means (6) comprise at least one radiofrequency communication module (12), preferably adapted to the IEEE 802.15.1 or IEEE 802.15.4 standard. The device (1) according to the invention is particularly intended for collective introduction to microcomputing and collective training in the use of software.

### TECHNICAL FIELD OF THE INVENTION

The present invention relates to a device for controlling a computer system, preferentially of the personal microcomputer type, by means of pointing devices, in particular of the wireless mouse type.

### TECHNOLOGICAL BACKGROUND OF THE INVENTION

The devices for controlling a computer system consisting in moving by means of a mouse, trackball or another pointing device, a cursor in order to indicate on the screen of the system an object, icon or element of a menu, representative of a function lo be carried out, are well-known.

These basic pointing devices, largely known in the field of microprocessing, relate only to the individual use of an information processing system. One knows possibilities of co-operating work of several people by the setting of several central processing units connected by a network. However, even if work is collective, each person personally controls each central processing unit by means of her/his own pointing device.

A system making it possible to several people to use the same central processing unit is described in the Japanese patent applications JP8221194 and JP9146703. The commands coming from several wireless mice can be received by a conventional microcomputer. To this end, a time-sharing radio transmission technique is implemented. The various mice transmit successively their data when they receive an identifying code sent by the basic station connected to the central processing unit corresponding to their own codes. The envisaged use is that of education and game.

An other example is the Japanese patent application JP10040002, which describes simultaneous operation of several mice in the same window.

The concept of a set of pointing devices controlling a single information processing system presents interesting prospects in particular in teaching. Contrary to the teaching of other disciplines, data-processing practices lends itself currently rather badly to collective courses. The training is rather based on the setting of practical working sessions, during which the pupils, by small groups of two or three, are exerted on a complete microcomputer. To let a great number of pupils to profit from an initiation, one thus needs large hardware resources permanently installed in specialized classrooms, having many power supply plugs.

The wireless mouse systems described above in the JP9146703, JP8221194 and JP10040002 patent documents would allow on the contrary a more traditional approach of initiation into handling of a computer. Each pupil having a mouse, could, under the control of a trainer, learn how to use a graphic interface, the image of which could be projected on a large-sized screen by means of an adapted data-processing peripheral, such as a video projector.

The economic advantage is obvious: only one information processing system is enough, which could consist of a portable microcomputer. The specialized rooms are not necessary any more, and the equipment can be installed quickly in any room.

However, this economic advantage is a bit limited, because the above described systems are not optimized for the pursued purpose.

In order to totally meet the needs of teaching, the international patent application WO02/10897 disclosed a device for controlling a computer system controlled by a group of users by means of several mouse-type pointing devices without wired connection with the system. Each pointing device communicates by infrared with a console connected to the system through a communication port. A multifrequency transmission technique and a frequency hopping coding are used. The graphic interface of the system is projected on a large screen for collective visual display. The console comprises a detachable receiver horn which enhances the range, and a set of switches for selecting the mouse or mice controlling one or several cursors of different shape and/or color. The advantage of an infrared connection is a total immunity to the radio disturbances.

The recent developments of short range radio link techniques, in particular those compliant with the IEEE 802.15.1 (Bluetooth) and IEEE 802.15.4 (ZigBee) standards, as well as evolution of operating systems of microcomputers allow to consider the replacement of all switches and/or of some wired connections of the system described in document WO02/10897 by software components, and/or wireless connections, respectively, in order to make deployment and use of this system easier when radio interference conditions are favorable.

### SUMMARY OF THE INVENTION

The present invention thus aims at optimizing the design of a device for controlling an information processing system.

It precisely has as an aim a device for controlling a computer system, preferentially of the personal microcomputer type, provided with a graphic interface, a master keyboard, a master pointing device and at least a communication port, at least by a group of users by means of several pointing devices without wired connection with the system, preferentially of the wireless mouse type. Each of the pointing devices is handled by each of the users and transmits by means of a communication channel sequences of binary data representative of displacements and states of these pointing devices to interface means connected to the communication port. The device further comprises means for selecting by a reference user one or more of the pointing devices and for disabling the others.

The device for controlling a computer system object of this invention is remarkable in that the selection means comprise at least a dedicated software module and in that the interface means comprise at least a radio frequency communication module, preferentially compliant with the IEEE 802.15.1 or IEEE 802.15.4 standard.

Preferably, this dedicated software module reads inputs originating in the master keyboard and/or the master pointing device.

Alternately, the selection means comprise a selection box connected by a first radio frequency connection, preferably compliant with the IEEE 802.15.1 or IEEE 802.15.4 standard, to the interface means, the selection box being provided with switches allowing the reference user to select one or more of the pointing devices and to make inoperative the others.

In this case, the selection box is advantageously a wireless alphanumeric keyboard.

In another configuration of the device for controlling a computer system according to the invention, the communication channel is set up by at least the radio frequency communication module arranged in the interface means.

These interface means then comprise advantageously at least an interface box provided with at least the radio frequency communication module.

Preferably, the interface box is connected to the communication port by a serial link, in particular of the USB type, or by a second radio frequency connection, preferably compliant with the IEEE 802.15.1 or IEEE 802.15.4 standard.

The interface box is advantageously provided with switches allowing the reference user to select one or more of the pointing devices and to make inoperative the others.

In still another configuration of the device for controlling a computer system according to the invention, the communication channel is preferably an infrared link, and the interface means comprise an electronic box for receiving the sequences of binary data transmitted by means of the infrared link by the pointing devices, and for emitting the sequences of binary data to the communication port by means of the radio frequency communication module.

In some configurations of the device for controlling a computer system according to the invention, the dedicated software module comprises instructions for simulating switches in at least one window of the graphic interface allowing the reference user to select one or more of the pointing devices and to make inoperative the others.

These few essential specifications make obvious for the expert the advantages brought by the invention compared to the background art.

### BRIEF DESCRIPTION OF THE DRAWINGS

FIG. 1 is a schematic diagram of the device for controlling a computer system by a group of users according to the invention.

FIG. 2 shows schematically a first preferred embodiment of the invention implementing a radio frequency communication module compliant with the ZigBee standard.

FIG. 3 shows schematically a second preferred embodiment of the invention implementing radio frequency communication modules compliant with the Bluetooth standard.

FIG. 4 shows schematically a third preferred embodiment of the invention implementing a radio frequency communication module compliant with the ZigBee standard and a selection box using a first radio frequency connection compliant with this standard.

FIG. 5 shows schematically a fourth preferred embodiment of the invention implementing a selection and interface box comprising a communications module compliant with the ZigBee standard and using a second radiofrequency connection compliant with the Bluetooth standard.

FIG. 6 shows schematically a fifth preferred embodiment of the invention implementing a communication channel formed by an infrared link between the pointing devices and a receiver electronic box provided with a communication module compliant to the Bluetooth standard.

FIG. 7 shows schematically a sixth embodiment of the invention implementing a communication channel formed by a an infrared link between the pointing devices and a receiver electronic box provided with a module compliant with the Bluetooth standard for communicating toward a selection and interface box connected with the computer system by a USB link.

FIG. 8 is a diagram of the hardware architecture of the selection box of the third preferred embodiment of the invention illustrated in FIG. 4.

FIG. 9 is a diagram of the hardware architecture of the selection and interface box of the fourth preferred embodiment of the invention illustrated in FIG. 5.

FIG. 10 is a diagram of the hardware architecture of the selection and interface box of the sixth preferred embodiment of the invention illustrated in FIG. 7.

FIG. 11 is a block diagram of the receiver electronic box of the fifth and sixth preferred embodiments of the invention shown respectively in FIGS. 6 and 7.

FIG. 12 represents symbolically a sample frame of data transmitted by the selection and interface box of the fourth and sixth preferred embodiments of the invention, and by the receiver electronic box of the fifth and sixth preferred embodiments.

FIG. 13 is a simplified diagram of the software architecture of a computer system controlled by the first embodiment of the controlling device according to the invention illustrated in FIG. 2.

FIG. 14 is a simplified diagram of the software architecture of a computer system controlled by the second embodiment of the controlling device according to the invention illustrated in FIG. 3.

FIG. 15 is a simplified diagram of the software architecture of a computer system controlled by the third embodiment of the controlling device according to the invention illustrated in FIG. 4.

FIG. 16 is a simplified diagram of the software architecture of a computer system controlled by the fourth or fifth embodiment of the controlling device according to the invention illustrated by FIGS. 5 and 6.

### DESCRIPTION OF PREFERRED EMBODIMENTS OF THE INVENTION

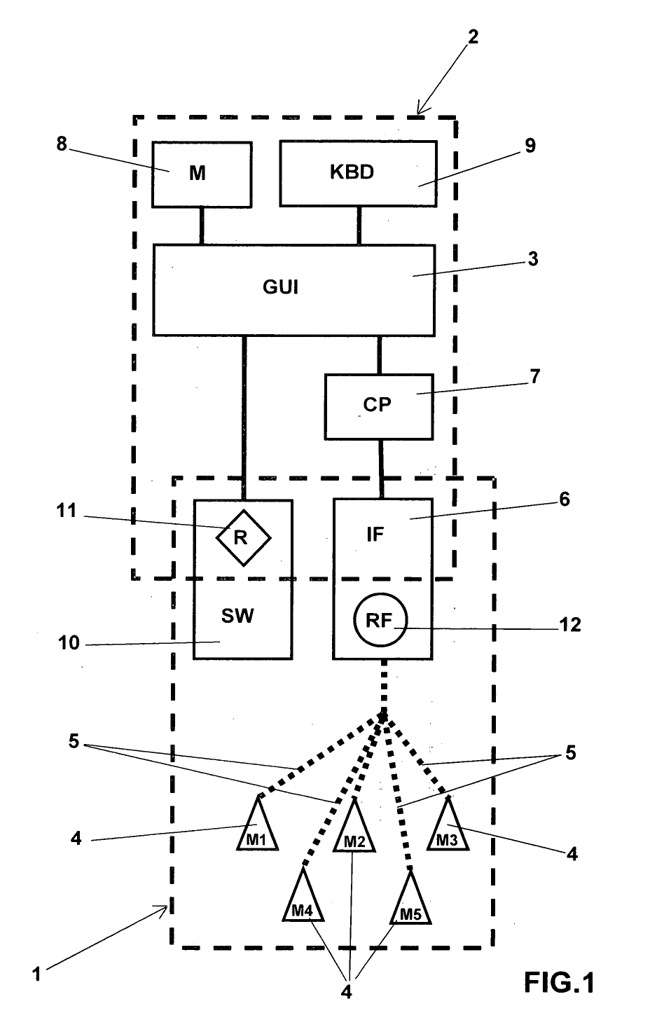

The references on FIGS. 1 to 16 will be used to explain in details the various characteristics of the invention.

The general concept of the controlling device 1 is illustrated by FIG. 1. A microcomputer 2 comprises an operating system presenting a graphic interface 3 that allows users to interact with the system by means of a screen display and pointing devices 4. The signals 5 emitted by the pointing devices 4 are received by interface means 6 connected to a communication port 7 of the central unit. The microcomputer comprises also a master pointing device 8 and a master keyboard 9.

The controlling device 1 according to the invention includes selection means 10 by a reference user of one or more of the pointing devices 4 and for disabling the others. To do this, the selection means comprise at least a dedicated software module 11.

The interface means 6 comprise at least a radio frequency communication module 12 compliant with IEEE 802.15.1 standard (known as “Bluetooth”) or IEEE 802.15.4 standard (known as “ZigBee”).

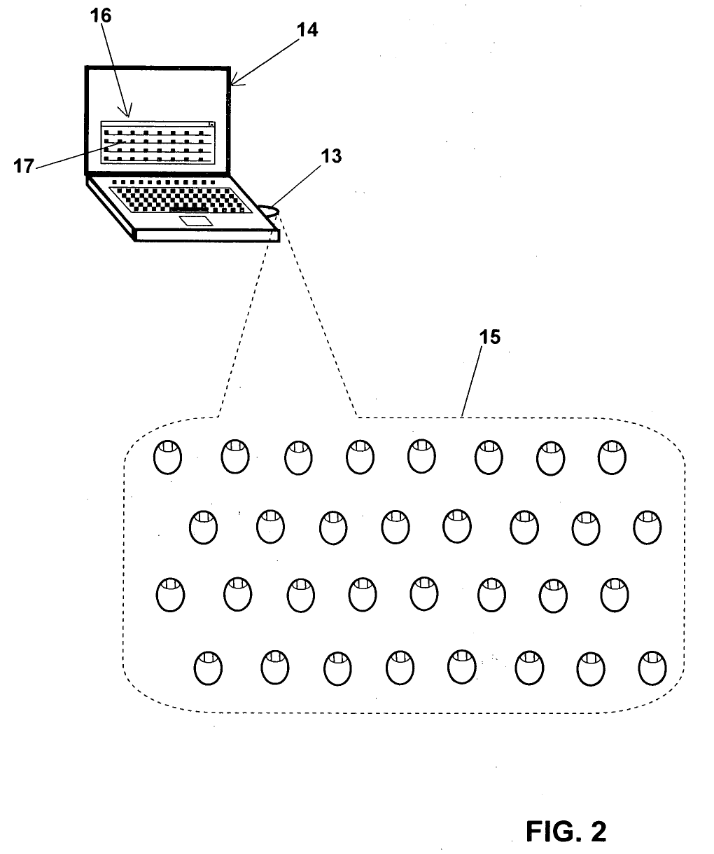

In a first preferred embodiment of the invention represented in FIG. 2, the radio frequency communication module 12 is compliant with the Zigbee standard.

It consists of a ZigBee USB dongle 13 inserted into a USB port of a portable microcomputer 14 receiving signals from a set 15 of wireless mice compliant with this communication standard, and available on the market.

The microcomputer 14 includes a dedicated software module 11 generating on its screen a window 16 simulating switches 17 allowing a reference user to select one or more of the mice 15 having control of application software, and to render ineffective the others on a single click.

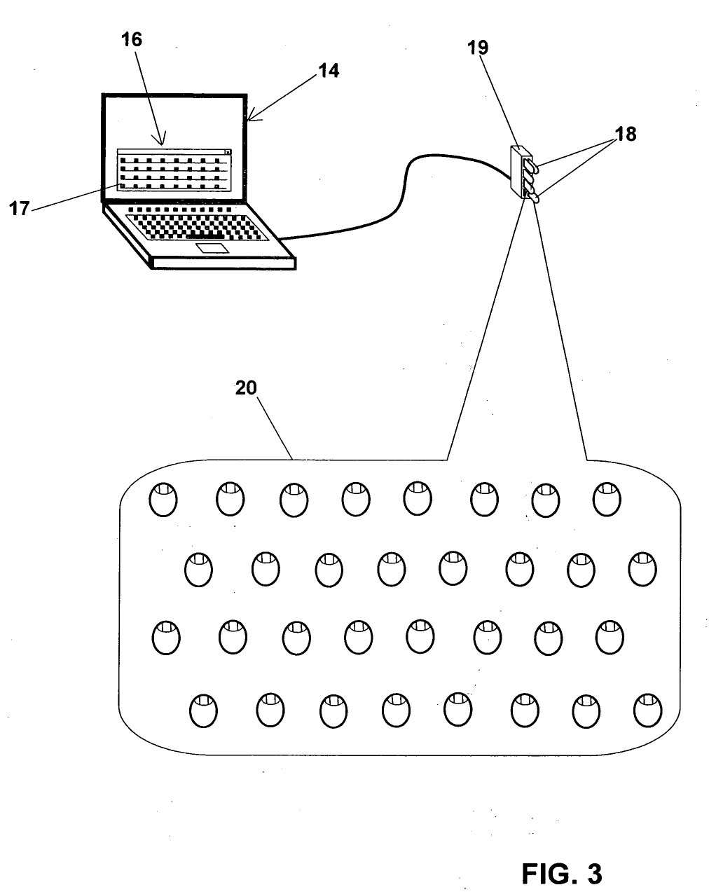

In a second preferred embodiment of the invention shown in FIG. 3, the interface means 6 include several radio frequency communication modules 12 compliant with the Bluetooth standard.

They consist of Bluetooth USB dongles 18 inserted in a USB hub 19 connected to a portable microcomputer 14, and receiving signals from a set 20 of wireless mice compliant with this standard, and available on the market.

Several Bluetooth dongles 18 are necessary for a set 20 of thirty-two mice, for example, because, according to this standard, a master controller cannot support more than seven slave devices.

As in the first preferred embodiment of the invention, the portable microcomputer 14 is provided with a dedicated software module 11 to select the mouse or the mice having the lead in using the graphic interface 3 of the operating system.

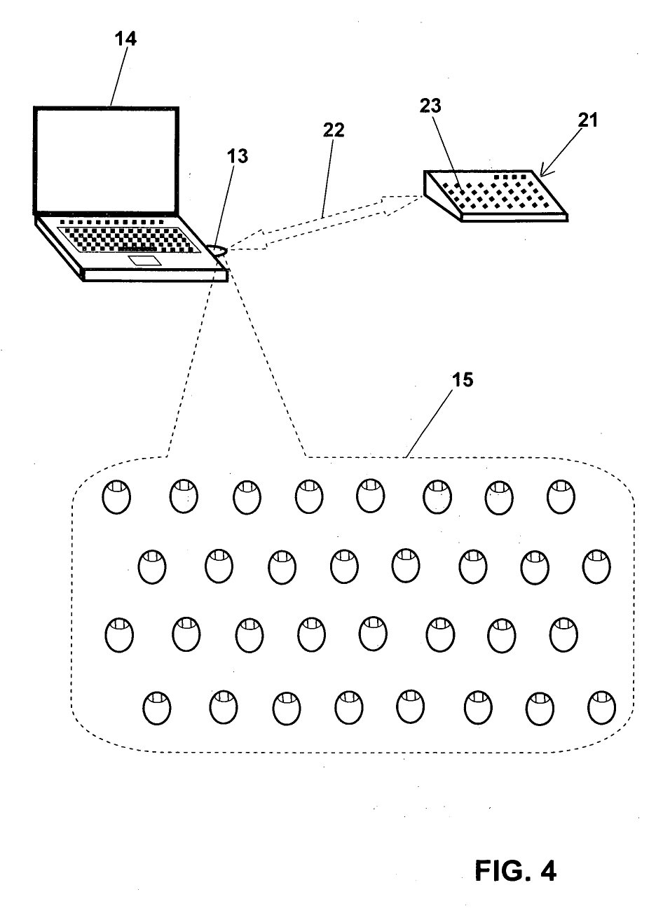

In a third preferred embodiment of the invention shown in FIG. 4, the interface means 6 involve, as well as in the first preferred embodiment of the invention, only one radio frequency communication module compliant with the ZigBee standard consisting of a ZigBee USB dongle 13 for receiving signals of a set of wireless mice compliant with the same standard 15.

In this embodiment, the selection means 10 include a selection box 21 connected to interface means 6 by a first radio frequency connection 22 compliant with the ZigBee standard.

The selection box 21, provided with switches 23, therefore communicates with the microcomputer 14 via the USB ZigBee dongle 13. The reference user selects by means of this box 21 the ZigBee mouse or mice having the lead.

The selection box 21 preferably has the form of a dedicated console, but alternatively, it is a standard ZigBee keyboard.

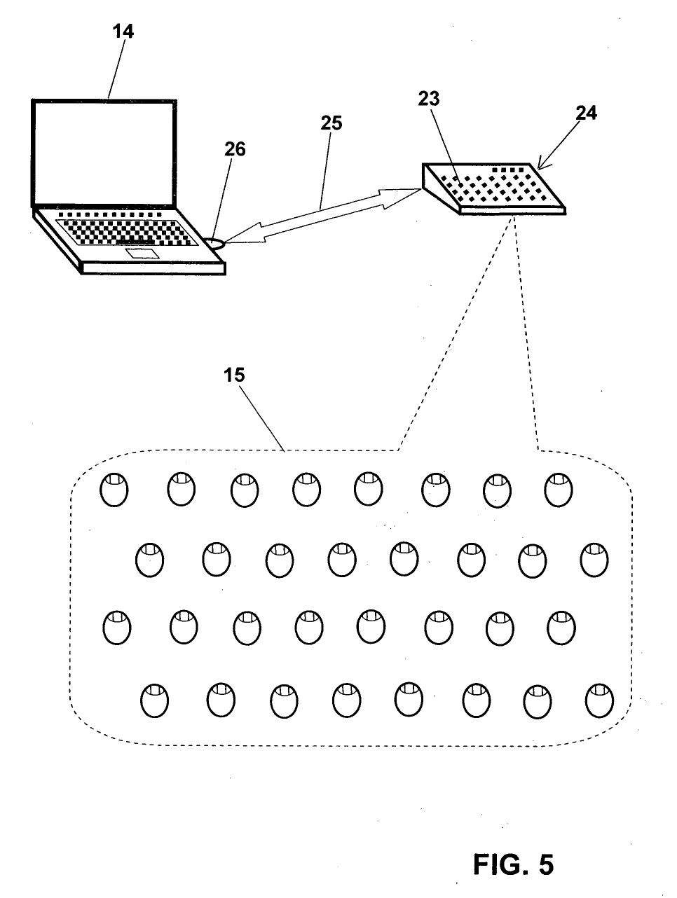

In a fourth embodiment shown in FIG. 5, a set of ZigBee wireless mice communicate with a selection and interface box 24 comprising a radio frequency communication module 12 compliant with this standard 12.

The selection and interface box 24 is connected to the microcomputer 14 by a second radio frequency connection 25 compliant with the Bluetooth standard to ensure sufficient bandwidth to transmit data from all the ZigBee mice 15.

For this purpose, the microcomputer 14 is provided with a USB Bluetooth dongle 26. The dedicated box 24 comprises switches 23 allowing, as in the previous embodiment, to select the active mice.

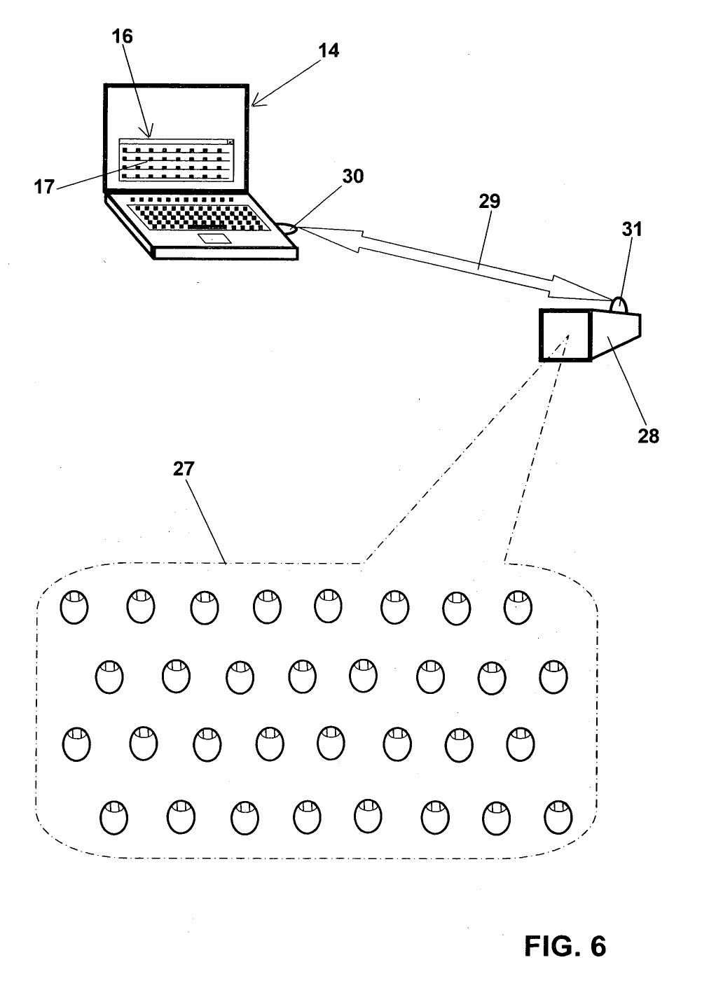

In a fifth preferred embodiment of the invention shown in FIG. 6, the communication channel between the wireless mice 27 and the interface means is an infrared link.

The signals emitted by infrared mice 27 are received and processed by a receiver electronic box 28, and the sequences of binary data corresponding to mice movements and statements of their buttons are transmitted to the microcomputer 14 by means of a broadband Bluetooth connection 29.

For this purpose, a communication port of the microcomputer 14 is associated with a radio frequency communication module consisting in a USB Bluetooth dongle 30, and the receiver electronic box includes a transceiver 31 compliant with the same standard.

As in the first and second embodiments, the microcomputer 14 includes a dedicated software module 11 for selecting the active mice with the help of the graphic interface 3 simulating a console 16,17.

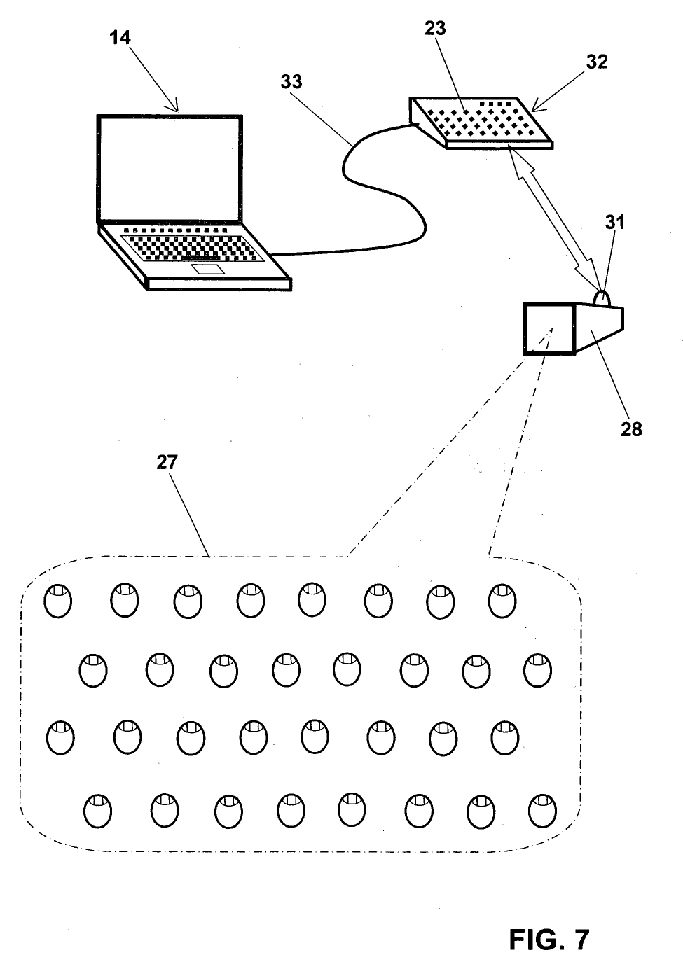

In the sixth embodiment of the invention shown in FIG. 7, the communication channel between the wireless mice 27 and the interface means 6 is also an infrared link. But the receiver electronic box 28 communicates via its transceiver 31 compliant with the Bluetooth standard with a selection and interface box 32 connected to the microcomputer 14 by a USB connection 33.

As in the third and fourth modes, the selection and interface box 32 comprise switches 23 to select the active mice.

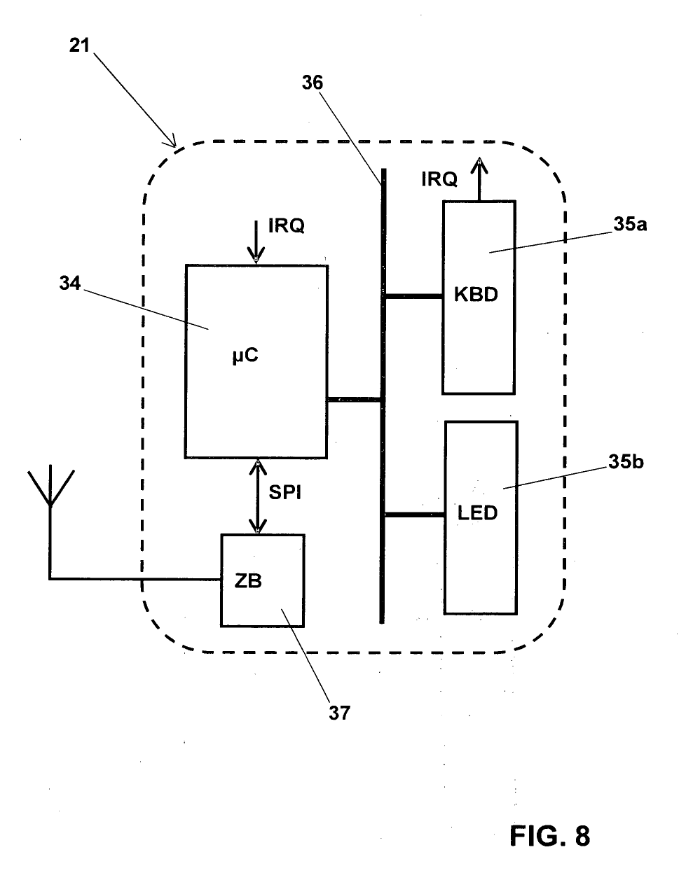

FIGS. 8,9 and 10 show diagrams of the hardware architecture of the interface and/or selection boxes of the third, fourth and sixth preferred embodiments of the invention, respectively, represented in FIGS. 4,5 and 7.

The selection box 21 of FIG. 8 is organized around an IRQ programmed microcontroller 34. When one of the switches 23 of the keyboard 35a of the console is activated, the generated IRQ is processed by the microcontroller 34 and triggers the acquisition of the status of the keyboard 35a via the system bus 36. The identification and status of the switch operated are transmitted by a serial peripheral interface SPI from the microcontroller 34 to a transceiver module 37 compliant with the ZigBee standard. The status lamp associated with the actuated switch, among a set of lamps 35b, is updated by the microcontroller 34 via the internal bus 36.

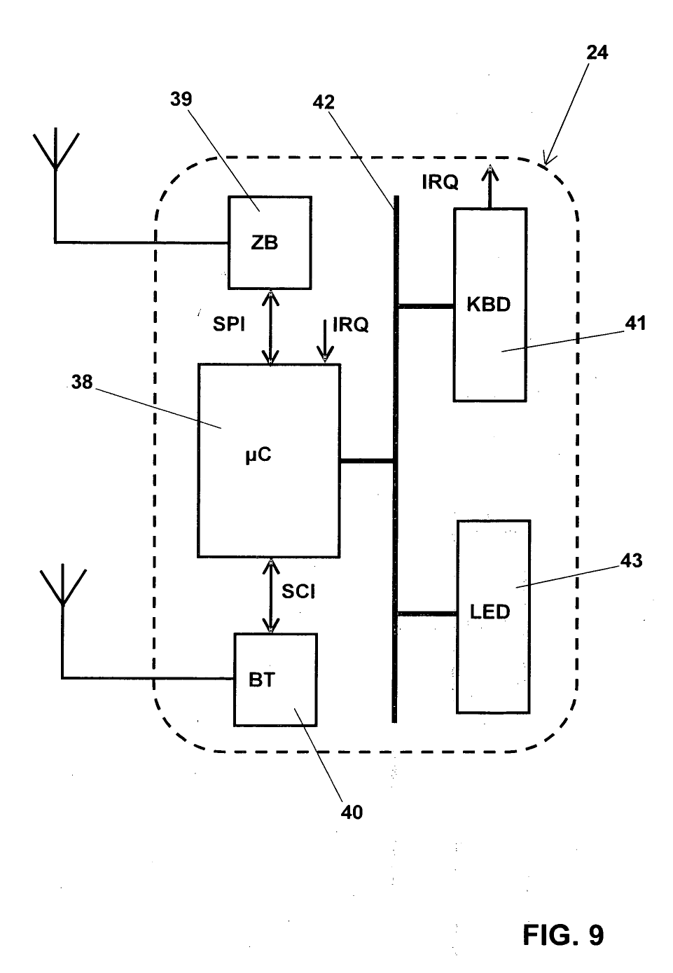

The selection and interface box 24, the architecture of which is shown in FIG. 9, receives the signals from all the ZigBee mice 15, identifies and multiplexes them, and transmits the resulting data frame to the micro-computer 14 by a Bluetooth connection 25. It includes therefore a microcontroller 38 receiving the sequence of binary data of the mice transmitted by a transceiver module 39 compliant with the ZigBee standard on a serial peripheral interface SPI, and retransmitting them, after selection, to a Bluetooth transceiver module 40 via a serial communication interface SCI. The selection of data, i.e. of active mice, is performed by a set of switches 41 connected to the system bus 42. The active/inactive status of mice 15 is shown by a set of lamps 43.

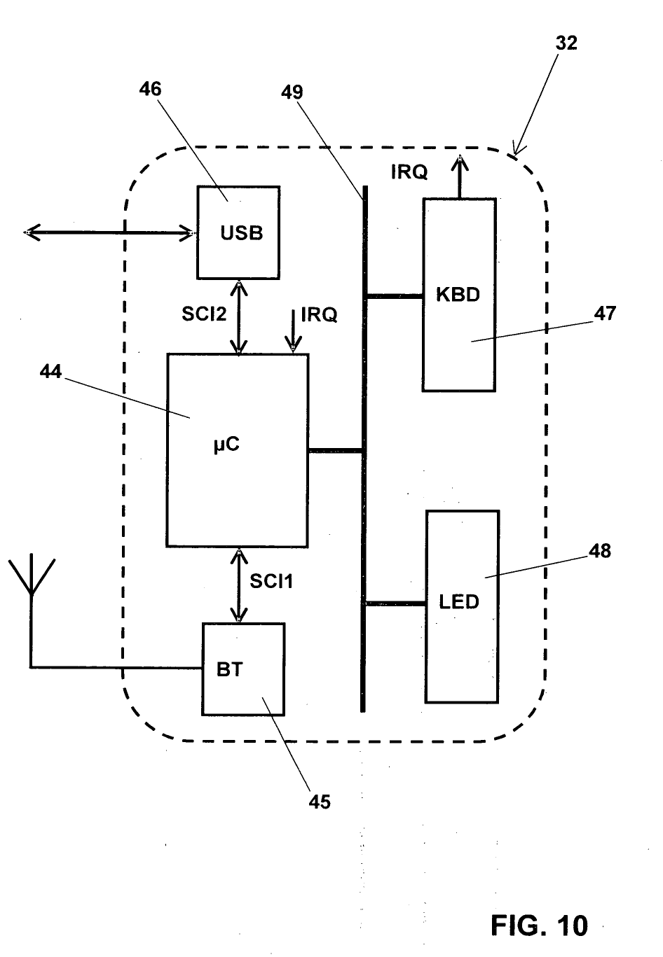

The selection and interface box 32, the architecture of which is shown in FIG. 10, receives the binary data sequence of the infrared mice 27, transmitted through the receiver electronic box 28 by means of a connection compliant with the Bluetooth standard, and transmits them via a USB serial link 33 to the microcomputer 14. For this purpose, the selection and interface box 32 comprises a microcontroller 44, a transceiver module 45 compliant with the Bluetooth standard and an USB interface module 46 connected to the microcontroller 44 by serial communication interfaces SCI1, SCI2. The selection and interface box 32 also comprises a set of switches 47 and a set of lamps 48 interfaced on the system bus 49, allowing the reference user to manage the activity of the mice 27.

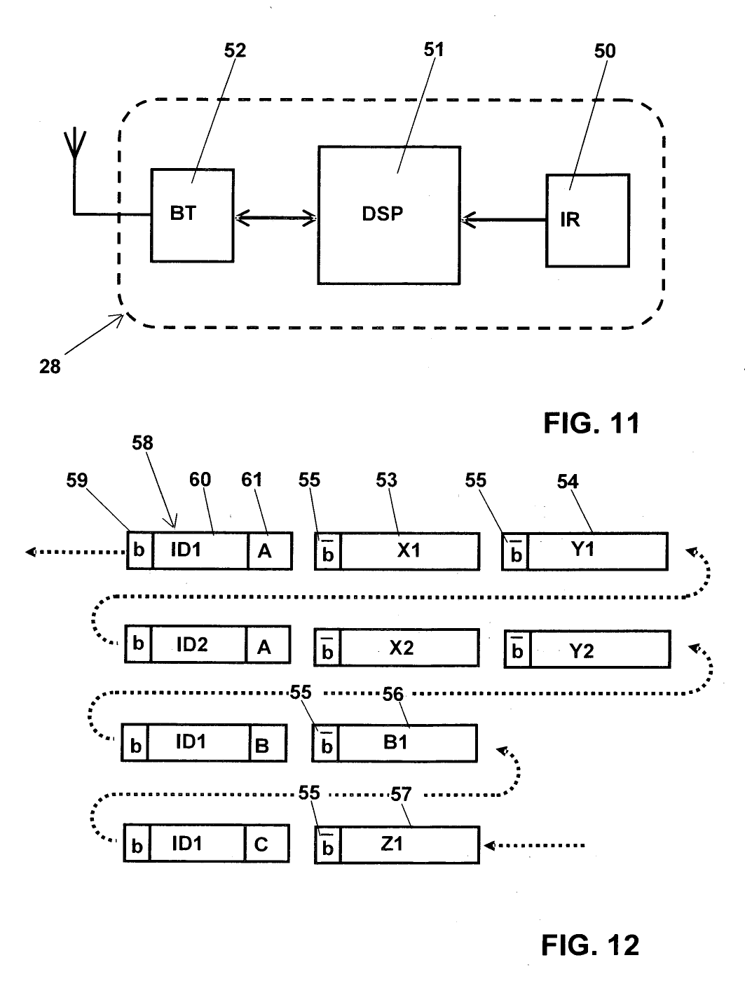

The fifth and sixth preferred embodiments of the invention represented in FIGS. 6 and 7 implement a receiver electronic box 28 the hardware architecture of which is shown in FIG. 11. The infrared light signals emitted by the infrared mice 27 are detected by an infrared receiver module 50 including a photodiode followed by amplifiers. The received analog signals are sampled and processed by a signal processing unit 51, which then transmits the binary data sequence corresponding to mice 27 in a multiplexed form to a transceiver module 52 compliant with the Bluetooth standard.

The structure of the frame of the multiplexed data is represented in FIG. 12. Displacements according to a transverse direction X1, X2 and in a longitudinal direction Y1, Y2 of each mouse 27 are encoded in a binary word 53,54 comprising a header field 55 specific to a data word. The states of the buttons B1 of each mouse, as well as the moving Z1 of the wheel, are in the same way coded in specific data words 56,57. Each data word 56,57, or group of data words 53,54, is preceded by a header word 58 comprising a specific header field 59 different from the header field 55 of a data word 53,54,56,57. The header word 58 includes an identification field 60 of the data emitting mouse following the header word 58, as well as a type field 61 containing the type (displacements X, Y, or Z, state of the buttons) of the data following the header word 58.

This frame structure is equally that of data transmitted by the Bluetooth link 25 between the selection and interface box 24 and the microcomputer 14 of the fourth embodiment of the invention represented in FIG. 5, as well as that of data transmitted by the USB serial link 33 between the selection and interface box 32 and the microcomputer 14 of the sixth embodiment of the invention shown in FIG. 7, except that only pass in this case the selected mice data.

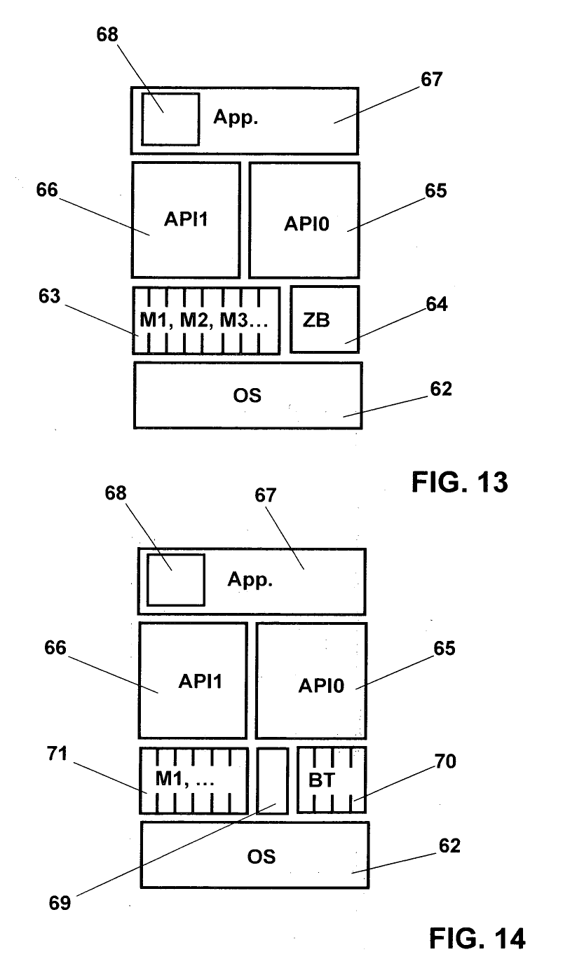

FIG. 13 shows the simplified software architecture of the microcomputer 14 controlled by the device shown in FIG. 2.

The operating system 62, such as Windows XP® from Microsoft Corporation®, supports multiple instances 63 of the ZigBee wireless mice 15 drivers, as well as the driver 64 specific to the ZigBee dongle 13 used. The native mouse system 65 of the operating system 62 allows the reference user to control the microcomputer 14 through a master mouse, or the touchpad.

An application program interface 66, based in the case of Windows XP® on the raw input API, allows the system of multiple mice 15 treated as HID devices (human interface devices) to control programs of the application layer 67 with cursors of different forms and/or colors.

The application layer 67 includes the simulation software 68 of a console for selecting active mice.

The software architecture, represented FIG. 14, of the microcomputer 14 supporting the controlling device represented FIG. 3 is similar to the previous one.

The need to use a USB hub 19 and several USB Bluetooth dongles 18 requires the loading of the driver 69 of the hub 19 and of the drivers 70 of the dongles 18, of several instances of the same driver if the dongles 18 are identical. As in the previous configuration, multiple instances 71 of the driver of the Bluetooth mouse used are loaded into the operating system 62.

If the total number of mice is at most equal to seven, only one Bluetooth USB dongle 18 is sufficient, and the USB hub 19 is not necessary, simplifying all as much the software architecture of FIG. 14.

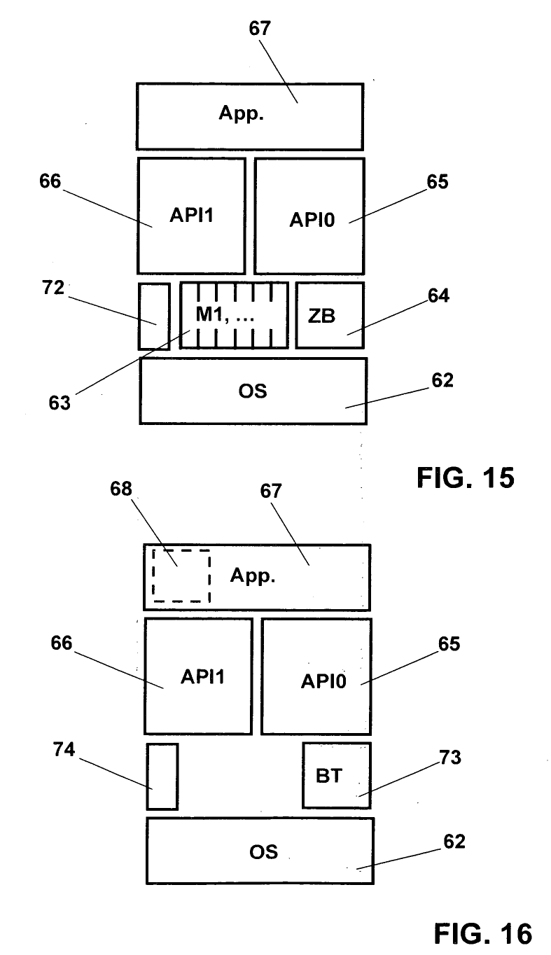

The software architecture shown in FIG. 15, corresponding to the device shown in FIG. 4, differs only from the architecture shown in FIG. 13 by adding the pilot 72 of the selection box 21 connected to the ZigBee USB dongle 13. The raw input interface API 66 is also used to interface the selection box 23 seen as a HID peripheral. In this configuration, the application layer 67 does not comprise any simulation software of a selecting console.

The software architecture shown in FIG. 16 is that of a microcomputer 14 controlled either by the controlling device shown in FIG. 5, or by the device shown in FIG. 6. A single instance 73 of the driver of the Bluetooth USB dongle 26,30 used is loaded in this case, unlike the general case of FIG. 14. But a driver 74 specific to the selection and interface box 32, or to the receiver electronic box 28 is loaded in these configurations. It stands to reason that the simulation software 68 of the selecting console is loaded solely in the case of the controlling system 1 having only the single infrared horn 28 (FIG. 6).

The controlling device 1 according to the sixth embodiment of the invention, represented in FIG. 7, requires no special software architecture other than loading the USB driver adapted to the selection and interface box 32, and an application program interface 66 to manage multiple cursors.

The advantage of the device for controlling 1 a sole computer system by a group of users by means of a plurality of pointing devices 4, the active pointing devices being selected by a reference user, described above, compared to the prior art, is precisely to keep a selecting functionality of these pointing devices, essential for the aimed applications in education and training, while providing greater flexibility of use by implementing short-range radio connections compliant with wide spread standards, where allowed by the radio environment and/or local regulations with regard to wireless telecommunications.

It is to be understood that the invention is not limited solely to modes of carrying out the invention given by way of examples above; it embraces, instead, all possible variants of realization that remain in the framework defined by the claims below.

1) Device for controlling a computer system provided with a graphic interface, master keyboard, a master pointing device and at least a communication port, at least by a user group by means of several pointing devices without wired connection with said system, each of said pointing devices being handled by each of said users and transmitting by means of a communication channel sequences of binary data representative of displacements and states of said pointing devices to interface means connected to said communication port, said device further comprising selection means by a reference user of one or more of said pointing devices and for disabling the others, characterized in that said selection means comprise at least a dedicated software module and in that said interface means comprise at least a radio frequency communication module.

2) Device for controlling a computer system according to claim 1, characterized in that said dedicated software module reads inputs originating in said master keyboard or said master pointing device.

3) Device for controlling a computer system according to claim 1, characterized in that said selection means comprise a selection box connected by a first radio frequency connection to said interface means, said selection box being provided with switches allowing said reference user to select one or more of said pointing devices and to make inoperative the others.

4) Device for controlling a computer system according to claim 3, characterized in that said selection box is a wireless alphanumeric keyboard.

5) Device for controlling a computer system according to claim 1, characterized in that said communication channel is set up by at least said radio frequency communication module arranged in said interface means.

6) Device for controlling a computer system according to claim 5, characterized in that said interface means comprise at least an interface box provided with at least said radio frequency communication module.

7) Device for controlling a computer system according to claim 6, characterized in that said interface box is connected to said communication port by a serial link, or by a second radio frequency connection.

8) Device for controlling a computer system according to claim 7, characterized in that said interface box is provided with switches allowing said reference user to select one or more of said pointing devices and to make inoperative the others.

9) Device for controlling a computer system according to claim 1, characterized in that said communication channel is an infrared link, and in that said interface means comprise an electronic box for receiving said sequences of binary data transmitted by means of said infrared link by said pointing devices, and for emitting said sequences of binary data to said communication port by means of said radio frequency communication module.

10) Device for controlling a computer system according to claim 1, characterized in that said dedicated software module comprises instructions for simulating switches in at least one window of said graphic interface allowing said reference user to select one or more of said pointing devices and to make inoperative the others.

11) Device for controlling a computer system according to claim 1, characterized in that said computer system is of the personal microcomputer type.

12) Device for controlling a computer system according to claim 1, characterized in that said pointing devices are of the wireless mouse type.

13) Device for controlling a computer system according to claim 1, characterized in that said radio frequency communication module is compliant with the IEEE 802.15.1 or IEEE 802.15.4 standard.

14) Device for controlling a computer system according to claim 1, characterized in that said dedicated software module reads inputs originating in said master keyboard and said master pointing device.

15) Device for controlling a computer system according to claim 3, characterized in that said first radio frequency connection is compliant with the IEEE 802.15.1 or IEEE 802.15.4 standard.

16) Device for controlling a computer system according to claim 7, characterized in that said serial link is of the USB type.

17) Device for controlling a computer system according to claim 7, characterized in that said second radio frequency connection is compliant with the IEEE 802.15.1 or IEEE 802.15.4 standard.
